(19) United States
(12) Patent Application Publication
(10) Pub. No.: US 2002/0109045 A1
(43) Pub. Date: Aug. 15, 2002

(54) Spherical LTA cargo transport system

(75) Inventors: Glenn Richard Beach, Annapolis, MD (US); Gregory Charles Ross Gottlieb, Berlin (DE); Charles Raymond Luffman, Staakow (DE)

Correspondence Address: Brian J. McNamara, Foley & Lardner, Washington Harbour, 3000 K Street, N.W., Suite 500, Washington, DC, 20007-5109, US

(73) Assignee: CARGOLIFTER, INC.

(21) Appl. No.: 09/988,230

(22) Filed: Nov. 19, 2001

Related U.S. Application Data
(60) Provisional application No. 60/252,088, filed on Nov. 21, 2000.

(51) Int. Cl. B64B 1/50

(52) U.S. Cl. 244/33

(57) ABSTRACT

A system and mechanism for the movement of large, outsized and heavy cargo includes a tow cable connectable at a first end to a towing vehicle, a buoyant lift vehicle comprising an inflatable member, a tether cable linked to the buoyant lift vehicle and having a connection with the tow cable, and a payload connector linked to at least one of said payload tether cable and said tow cable. The tow cable has a tow vehicle connector at a first end. A connector links the tether cable and the tow cable.

### RELATED APPLICATIONS

This application claims priority to Provisional Application Serial No. 60/252,088, filed on Nov. 21, 2000 under 35 U.S.C. §119(e). The content of the Provisional Application Serial No. 60/252,088 is hereby incorporated by reference.

### FIELD OF THE INVENTION

The invention relates generally to the field of transport systems, and more specifically, to a system and method for transporting large volume and heavy payloads using lighter-than-air (LTA) technology coupled with an external tow vehicle.

### BACKGROUND OF THE INVENTION

There exists a need for devices to lift and move heavy and outsized equipment, and to position them at a destination point with precision and in a manner not requiring a runway. At times, roads or infrastructure do not exist to enable equipment, such as large turbines, construction elements or cargo elements, to be moved safely or efficiently from a point of origin to a final destination. In general, the average speed for movement of such payloads is in the order of 5 mph, and the modifications necessary to reinforce bridges or create roads to support the transportation of such payloads can be several times more costly than the item being moved. A practical and useful system using LTA technology, however, has yet to be developed.

Designs for moving very large volume and heavy payloads have been investigated for many years. Concepts in publications include the aerocrane and cyclo-crane as well as a helicopter powered heliostat. In fact, NASA investigated a quad-rotor heavy lift device which integrates lighter-than-air (LTA) as an element of the design. For various reasons, none of these approaches have been commercially successful.

The present limit for the existing heavy lift helicopters, such as the Sikorsky MH-53E series, is a tow tension of 40,000 pounds when using a proven AMCM TOW boom/hook system. The Mi-26 designed in Russia has a published top and vertical life capability of 44,000 pounds. The CH-47 Chinook used by the U.S. Army has a capability of 6,000 pounds for suspended external loads.

There are situations where it is necessary to transport heavy loads weighing in the order of 40-100 tons over distances of up to 150 km. These situations may include, for example, disaster aid relief, commercial applications such as remote mining operations, and both military and commercial applications for ship to shore transport of heavy and large volume goods. Such situations call for a capability to lift and transport 80,000 pounds to 200,000 pounds. Obviously, this weight exceeds the capacity of existing air transport systems such as helicopters, which can precisely position payloads onto the ground in a hover mode.

There is no current system that allows the transport of loads in the range of 40-100 tons. For example, a system with this capacity would have been extremely useful in the recent Kosovo crisis for both commercial and military applications, or for Mozambique to save lives or provide post-flood aid. In Mozambique for example, 50 foreign helicopters worked for 48 hours continuously and were able to transport just 98 tons of aid supplies. A transport system capable of moving loads of 50-75 tons could have moved the 98 tons of aid supplies with only two helicopter or system flights.

Such a transport system would be equally useful for aid relief in a crisis such as that experienced in California, Turkey, or Japan during the earthquakes of the last two decades. Prefabricated mobile hospitals and other devices could be airlifted into required locations for immediate use after such disasters.

### SUMMARY OF THE INVENTION

In one aspect of the present invention, s payload transport system includes a tow cable connectable at a first end to a towing vehicle, a buoyant lift vehicle comprising an inflatable member, a tether cable linked to the buoyant lift vehicle and having a connection with the tow cable, and a payload connector linked to at least one of the payload tether cable and the tow cable.

In another aspect of the present invention, the payload connector links ends of the tether cable and the tow cable, the ends including an end of the tether cable distal from the buoyant lift vehicle and an end of the tow cable distal from the first end thereof.

In a further aspect of the present invention, the buoyant vehicle includes an aerostat having a substantially constant drag coefficient under predetermined transport conditions, the drag coefficient being less than about 0.20.

### DESCRIPTION OF THE DRAWINGS

FIGS. 1 and 2 are known graphs of drag coefficients against Reynolds numbers.

FIG. 3 is a diagram of a heavy cargo transport system consistent with the present invention.

FIG. 3A is a diagram showing additional elements of the heavy cargo transport system of FIG. 3.

FIG. 3B is a graph showing towing feasibility for different drag coefficients.

FIG. 4 is a diagram of another heavy cargo transport system consistent with the present invention.

FIG. 5 is a diagram of a landing procedure for the heavy cargo transport system of FIG. 3.

FIG. 6 is a diagram of a landing zone and winch system for a heavy cargo transport system consistent with the present invention.

FIG. 7 is a graph showing the relationship of peak current to percentage of lightning strikes.

FIG. 8 is a diagram of a heavy cargo transport system consistent with the present invention in a moored configuration.

FIG. 9 shows diagrams of tow cable configurations for the heavy cargo transport system of FIG. 8.

FIG. 10 is a diagram of suspension lines for the heavy cargo transport system of FIG. 8.

FIG. 11 is a diagram of the attachment of a load frame to an LTA sphere in the heavy cargo transport system of FIG. 8.

FIG. 12 is a diagram of a mooring line configuration of the heavy cargo transport system of FIG. 8.

FIG. 13 is a diagram of a payload box for the heavy cargo transport system of FIG. 8.

### DETAILED DESCRIPTION OF THE PREFERRED EMBODIMENT

In one aspect of the invention, an aerodynamic characteristic of large spherical shapes towed through the air by a separate manned tow vehicle is used to realize a low drag coefficient while also providing the optimal shape for LTA efficiency and offering lift augmentation to either helicopters, VSTOL aircraft, or the ability to carry large outsized cargo through the air while being towed by ground movers. A cargo transport system consistent with the present invention serves a need since there remains a worldwide requirement for the short haul transport of items weighing up to 100 tons. This category includes the following by example:

| | |
|---|---|
| Main Battle Tank/Ship to Shore | 65 tons |
| Crane Shovel | 40 tons |
| Int'l Std Container 8 × 8 × 40 ft | 36 tons |
| SEALAND Commercial Container | 28 tons |
| Logging Operations | 25 tons |
| MIL Van 8 × 8 × 20 ft/Ship to Shore | 22 tons |

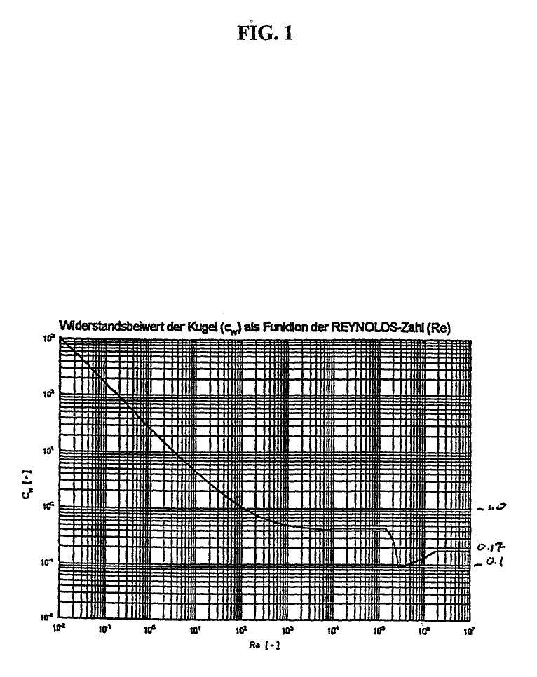

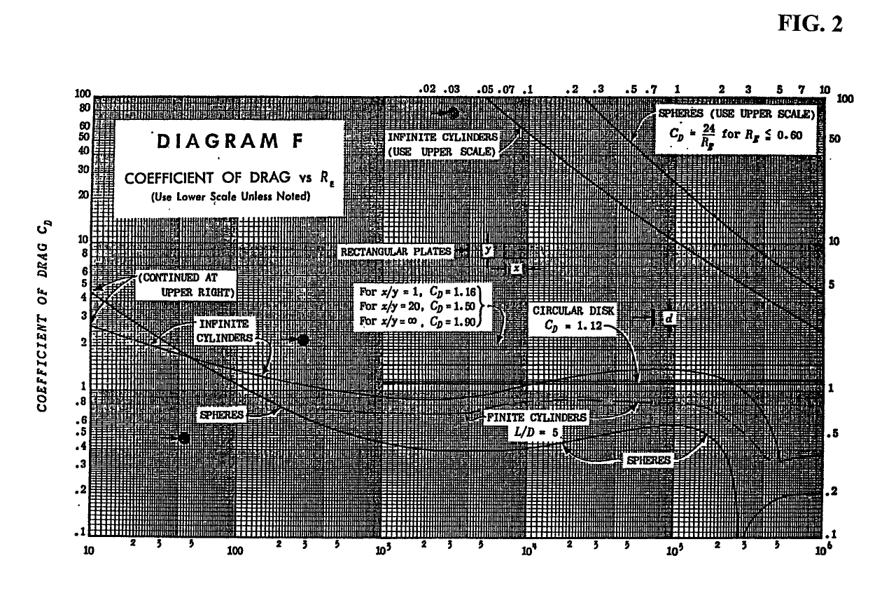

A large spherical LTA vehicle is affected by two physical laws, the drag coefficient and buoyant lift. The drag coefficient on large spherical objects in air decreases as the size of the sphere grows very large. As shown in FIG. 1, as determined by a university source at the space institute in Achen Germany, the drag coefficient plateaus at about 0.17 when the Reynolds number of a sphere exceeds 1,000,000. This finding corresponds very well with the graph published in the United States by McGraw-Hill shown in FIG. 2, which indicates that the Reynolds number plateaus at about 0.2 for Reynolds numbers above 600,000.

Furthermore, work performed for the John Hopkins University speculates that the actual Reynolds number may be as low as 0.13 for spheres with extremely high Reynolds numbers. Since the Reynolds number is a function of the velocity of the passing air, the diameter of the body and of the kinematic viscosity, a relationship can be derived for the Reynolds number versus air at any given temperature and pressure.

For example, at 68 degrees F, and 1 atm pressure, the Reynolds number is 95,000,000 in a 45 knot relative wind for a 200 ft diameter sphere. This value exceeds the necessarily high Reynolds number per the physical law criteria shown in the graphs of FIGS. 1 and 2. Therefore, the resultant drag coefficient is in the order of 0.17 to 0.20, depending on the reference source selected. As the drag force is a direct function of the drag coefficient, the smaller drag coefficient works in the favor of a very large LTA vehicle.

Buoyant lift, such as that provided by lighter-than-air vehicles, does not have the inherent limitations on payload capacity as does dynamic lift, such as that used in fixed or rotary wing aircraft. A large conventional dynamic lift aircraft follows the principle of a Square-Cube Law. In accordance with this law, the lift increases with the square of the vehicle's principle dimension, while the aircraft empty weight increases with the cube. This principle causes the vehicle structural weight to increase faster than the lift as the size of the gross vehicle weight is increased. Therefore, as the size is increased, the percentage of the total weight available for useful payloads is decreased.

In contrast, buoyant lift vehicles follow the Cube-Cube Law. According to this law, buoyant lift vehicles have approximately the same efficiency of structural weight to gross vehicle weight at all sizes. In other words, there is no diminishing effect caused by making the buoyant lift vehicle larger. In fact, with modern materials technologies, it is entirely feasible to make very large non-rigid LTA vehicles. Using standard aerodynamic calculations, the calculation for the diameter of a sphere capable of lifting a nominal 60 ton payload would be approximately a 157 ft diameter sphere, assuming the following values:

133,633 pounds of gas lift using helium

Less-

6,500 pounds for the flexible structure;

1,300 pounds for the power generator;

500 pounds for miscellaneous system elements such as lightning protection;

3,000 pounds for the payload frame; and

1,000 pound for rigging.

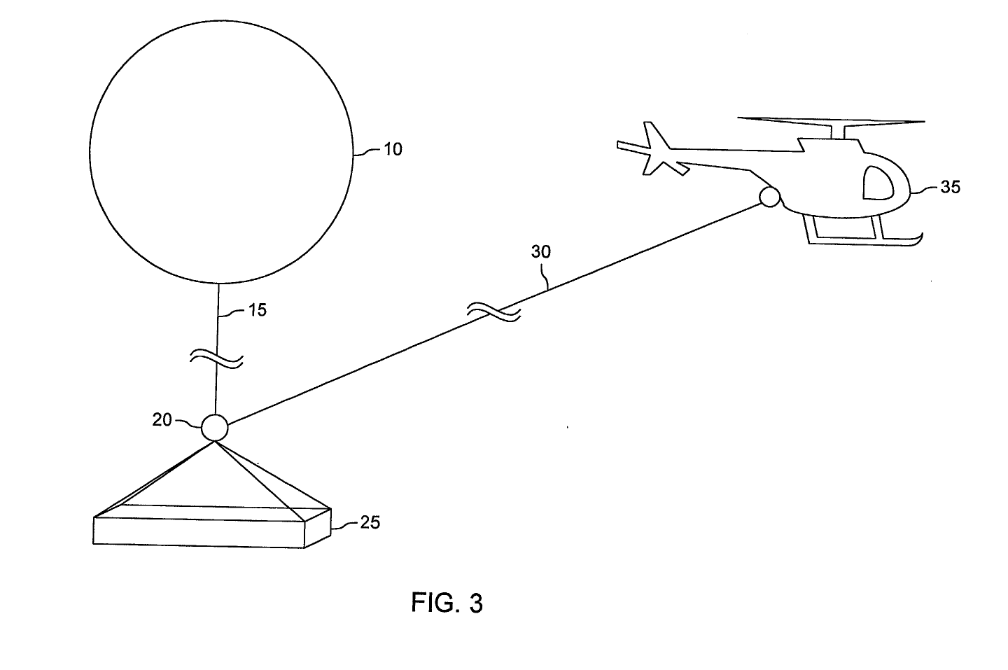

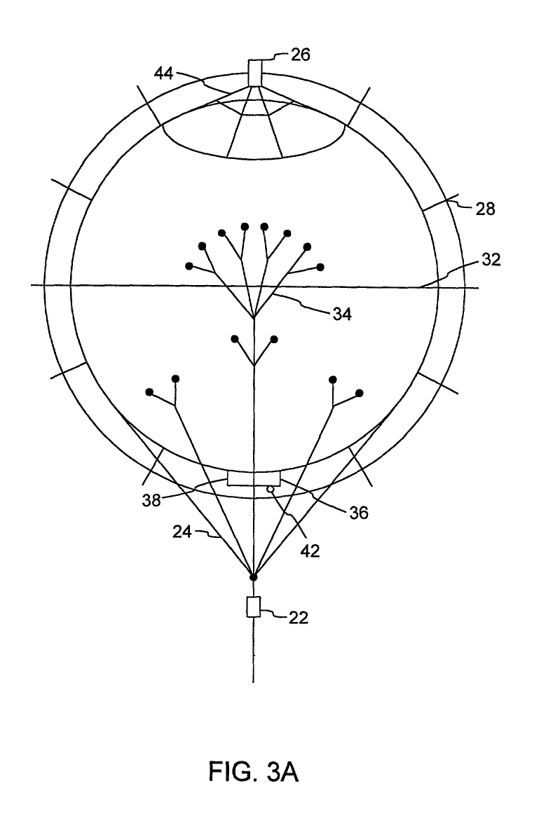

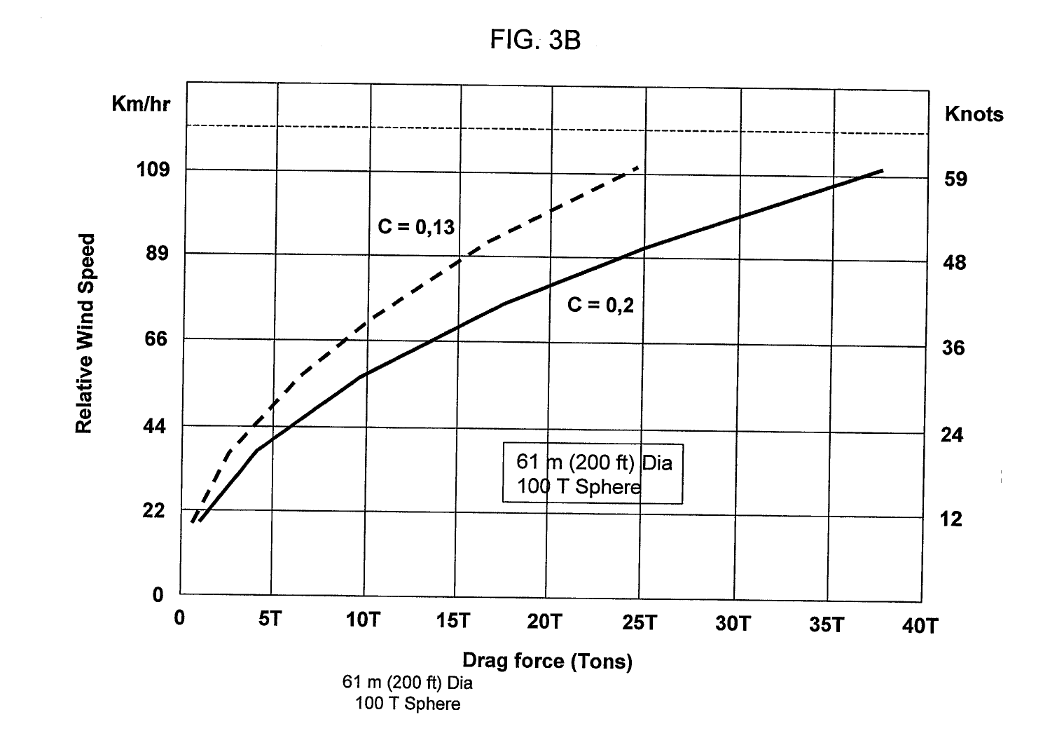

FIG. 3B shows a graph illustrating the tow feasibility for a tow vehicle in high relative winds. The tow feasibility is shown for drag coefficients, C_{D}, at 0.13 to 0.20. As shown in FIG. 3B, each curve shows the limit for the speed of a tow vehicle, such as a helicopter, for different drag forces. For example, at a drag coefficient of 0.20, the maximum speed for the tow vehicle for a drag force of 30 tons is approximately 54 knots.

FIG. 3 is a diagram of a heavy cargo transport system consistent with the present invention. As shown in FIG. 3, the transport system includes an airborne vehicle or balloon 10, a tether cable 15, a tri-plate connector 20, a payload box 25 and a tow cable 30. The tri-plate connector 20 is located at the confluence point of the tether cable 15 and is attached to the tow cable 30. The tether cable 15 is connected to the payload box 25 via the tri-plate connector 20, as shown in FIG. 3. Alternatively, the tether cable 15 may be connected directly to a payload instead of the payload box 25. The tether cable may be about 200 to 300 feet in length between the balloon 10 and the tri-plate connector 20. The tether cable 15 may include lightning protection and an electromechanical element for transferring power from a generator (not shown) located on the payload box 25. The generator provides power for blowers and controls on the transport system to maintain pressure in the balloon 10.

The balloon 10 is preferably a non-rigid structure operating at about 2.5 inches of water gauge differential to the dynamic pressure on the surface of the balloon 10. The dynamic pressure may be measured by a series of pitot tubes located at the balloon 10. The diameter of the balloon 10 may be about 146 feet and have a volume of about 1.6 million ft³. The payload box 25 may have a length of about 40 feet and have a height and depth of about 12 feet each. The payload box 25 may be designed with a metallic or lightning resistant outer perimeter, and may be supported by either composite fabrication, or aircraft aluminum structural construction approaches, to minimize weight and maintenance.

In another aspect of the present invention, an airborne slipring 22 may be included between the balloon 10 and the tether cable 15, as shown in FIG. 3A. With the airborne slipring 22, a plurality of confluence lines 24 may be attached to the balloon 10 and merge into a single junction just above the airborne slipring 22. The airborne slipring 22 may be constructed to handle high voltage power transmission consistent with the overall delivery required to the transport system. It may be fitted with water-tight, corrosion resistant connectors and may include a clevis joint for connection to a confluence point tri-plate. The airborne slipring 22 may also be fitted with a 90 degree adapter at the lower end for adaptation to a fitting accepting a termination connecting to the tether cable 15.

The airborne slipring 22 is preferably designed and rated appropriately and may incorporate surge protectors, such as metal oxide varistors and clamping diodes, between the center conductors and a metallic tether shield in the event of a lightning strike. The configuration is preferably capable of withstanding a 150,000 ampere lighting strike without catastrophic damage to either the tether cable 15 or the balloon 10. The airborne slipring 22 may need to be replaced after such a strike, but it should withstand such a large strike without mechanical failure.

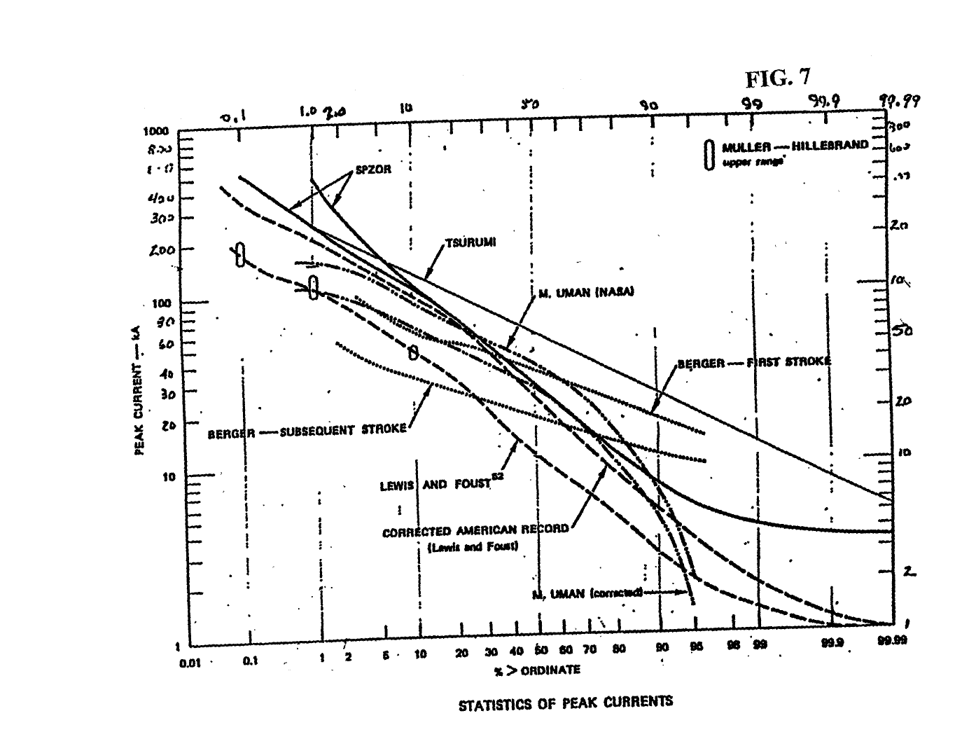

It should be noted from data provided in FIG. 7 that 99% of lightning strikes in nature should not have peak currents greater than 150,000 amperes. Since the action integral of a lightning strike is a summation of charge and time, the current is a major determining factor in creating damage from a strike. Substantial protection should be provided in the shield of the tether cable to protect from such strikes.

In addition to the airborne slipring 22, FIG. 3A further shows that the transport system may include a strobe navigation light assembly 26, a lightning protection subsystem 28, a rain curtain 32, a close haul rigging 34, a telemetry and command system 36, a power distribution and control system 38, an anemometer and pitot assembly 42 and an ARDD (Airborne System Rapid Deflation Device) device assembly 44.

The telemetry and command subsystem 36 is capable of monitoring system pressures, windspeed at airborne pitot tubes, blower states, valve status, temperature, and airborne tether tension. The information may be capable of being transmitted via radio link, or preferably via optical fiber link, to either a ground moving vehicle, or to an airborne tow vehicle, such as a helicopter 35 positioned approximately 600-1000 ft away from the lifting vehicle attachment point.

The lightning protection subsystem 28 may be fitted with a lightning cage, which also shields the ARDD device assembly 44 located at the top of the balloon 10, from stray current. The cage may be constructed from aluminum standoff poles toped with aircraft style electrostatic diffusers. Stringer wire may be a minimum NO. 2 AWG or equivalent aluminum wire. There may be four wires extending from the apex of the balloon 10, and these can be bonded at the base of the balloon 10 in a manner which shields the electronic life-support and telemetry/power boxes. The lightning protection subsystem 28 may then run through the outer shield of the tether cable 15 to terminate at the exterior of the payload box 25. Lightning diffusers, such as dischargers, may be installed on the payload box 25 to dissipate any current which attaches due to a strike. The use and capabilities of static dischargers are well known.

The lightning protection subsystem 28 may comprise a braided matrix consisting of Copper-Chromium alloy configured in a hybrid braid, and stabilized with an appropriate stabilization yarn such as a urethane treated Dacron-polyester cordage. The lightning protection subsystem 28 is preferably capable of preventing catastrophic mechanical failure of the tether cable 15 from a 150,000 ampere strike. Approximately 0.06 pounds per foot of metallic braid protection is preferably provided to completely protect the tether cable 15. The lightning protection subsystem 28 may be bonded to wires, which trail from the payload box 25, such that they will touch the ground prior to handling by personnel, and thereby discharge electrostatic charges.

The tether cable 15 may include integral, corona free, power conductors. AC corona test voltage may be adjusted by an altitude factor of 2,000 feet and using a 1.5 times factor over peak operational voltage. The tether cable 15 may have an ultimate strength in excess of 200,000 pounds. The strength member may be Vectran, aramid or other suitable high tenacity fiber. The tether cable 15 may be covered with a 25 mil minimum thickness of semi-conductive black polyurethane, which is pressure extruded into the interstices of the hybrid braid. The semi-conductive black polyurethane provides electrostatic shielding for the power conductors.

The tether cable 15 may be configured for use between the payload box 25 via the tri-plate connector 20, and the airborne slipring 20. The tri-plate connector 20 connects vertically between the payload box 25 and the tether cable 15, and at approximately a 45 degree angle to the towing cable 30 for airborne tow configurations.

As shown in FIG. 3, the tow cable 30 is attached to the helicopter 35. The tow cable 30 may be formed with the same material as the tether cable 15 and may have a length of about 1000 feet. The helicopter 35 may include load sensing devices and may be attached to the tow cable 30 such that the tow cable 30 can be immediately severed from the balloon 10 if the tow tension exceeds predetermined limits for safe flight.

The tow cable 30 in a towing configuration using the tri-plate connector 20 may comprise two cables with differing elongation characteristics. The part of the tow cable 30 connecting to the tri-plate connector 20 adjacent to the payload frame 25 may be a “Sampson,” or equivalent, Dacron polyester cordage braid with an ultimate breaking strength of 100,000 pounds. This part of the tow cable 30 may extend for about 200 feet. It may then be connected to another approximately 800 ft long part of the tow cable 30 constructed from a braided miniline construction of either Vectran or Technora. A UV abrasion protection may be provided on the jacket for the 800 ft long part of the tow cable 30, which may have a breaking strength rating to ultimate of between about 110,000 and 120,000 pounds.

In operation, the payload box 25 may be ballasted such that the transport system is in the order of only 1,000-6,000 pounds heavy. Pounds heavy means that the weight of the payload box 25 exceeds the buoyant lifting force of the balloon 10, whereas pounds light means that the buoyant lifting force exceeds the weight of the payload box 25. With the transport system only 1,000-6,000 pounds heavy, the helicopter 35 may easily lift the payload box 25 as the majority of the necessary lift is provided by the buoyant forces of the lifting gas in the balloon 10.

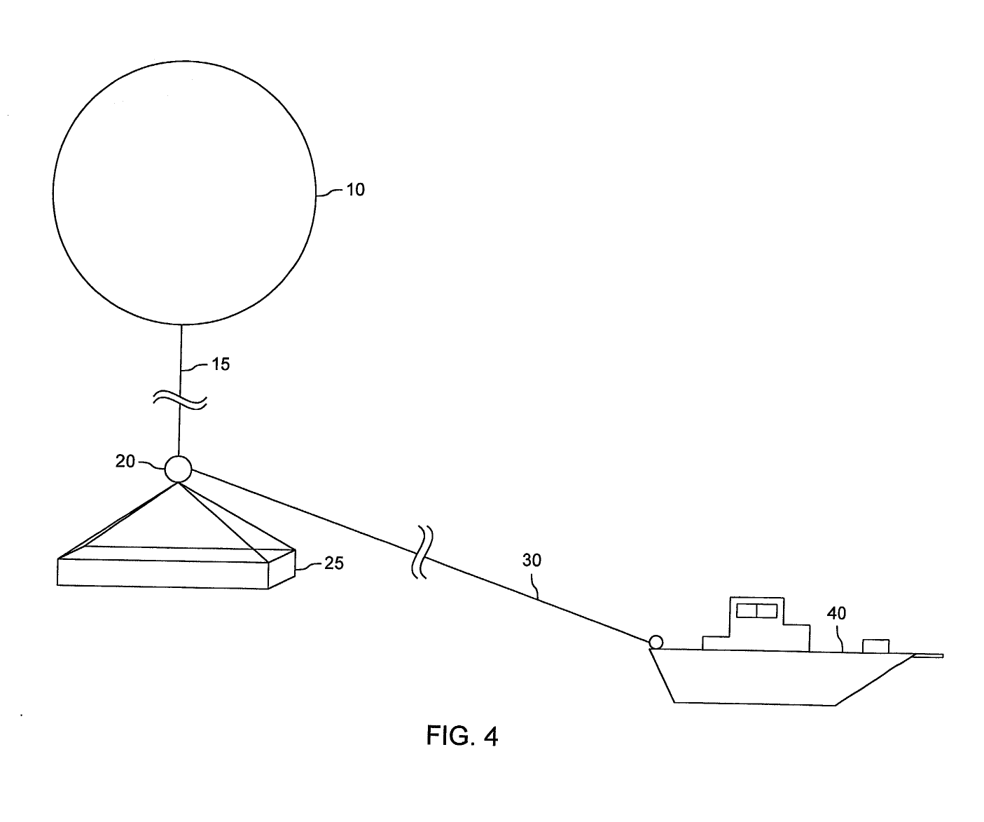

FIG. 4 shows the heavy cargo transport system of FIG. 3, but with a ground mover 40 instead of a helicopter 35. The ground mover 40 may be, for example, a hovercraft, a land vehicle, or a ship. The ground mover 40 may be configured so that the buoyant lift is in the order of 1,500 pounds light. As a result, the payload box 25 will be lifted by buoyant forces, and towed by the ground mover 40.

In the case of the ground mover 40, the balloon 10 lifts the payload box 25 (and ballast, not shown) to an altitude of approximately 300-600 ft above the ground. In this case, the balloon 10 may be positioned approximately 300-600 ft above the ground mover 40. The balloon 10 and ballast may be configured so that the payload box 25 has approximately 1,500 pounds of free lift exerted on it due to the buoyant forces of the balloon 10.

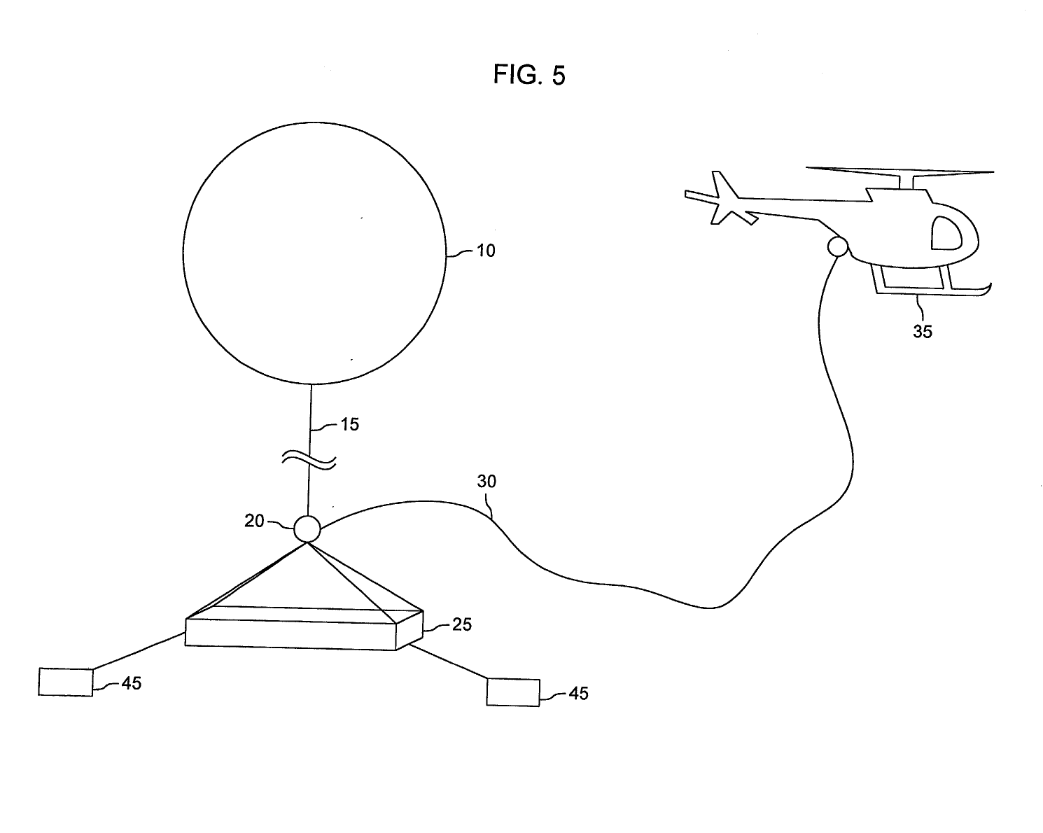

FIG. 5 shows a landing and take-off procedure for the heavy cargo transport system of FIG. 3. As shown in FIG. 5, the transport system includes tie-down winches 45, which hold the payload box 25 and balloon 10 during the landing and taking off procedure. This arrangement allows loads to be transferred easily to the winches 45 when the payload is landed or pulled down at its final destination.

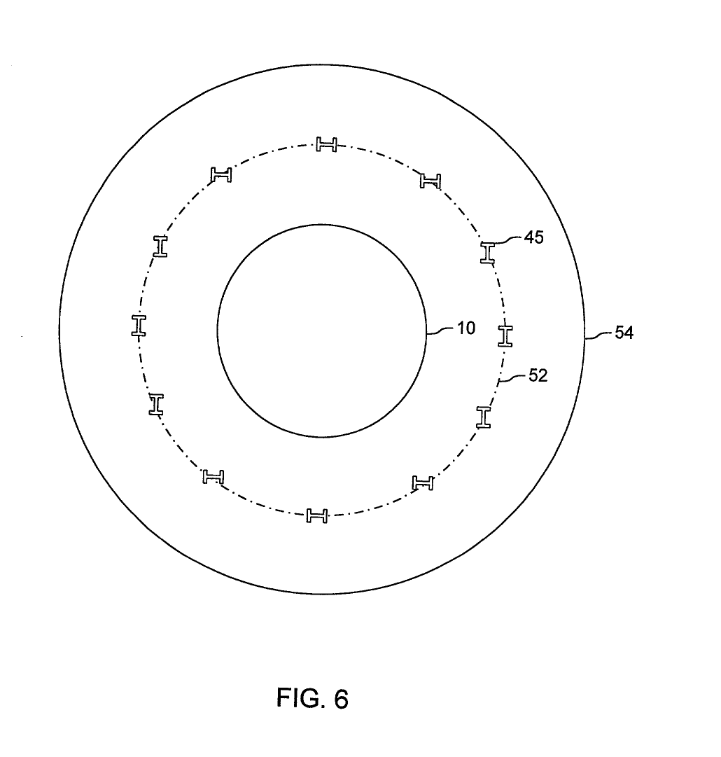

FIG. 6 shows a landing zone 54 for the payload box 25 of the heavy cargo transport system of FIG. 3. As shown in FIG. 6, the landing zone 54 includes several ground winches 45 arranged radially on a ring 52. The diameter of the ring 52 may be about 150 feet in diameter. The winches 45 are preferably spaced equidistantly around the ring 52. The winches 45 may be temporarily augered to the ground or fastened using known RED-Head technology. It is unnecessary to pour concrete or foundations for these items.

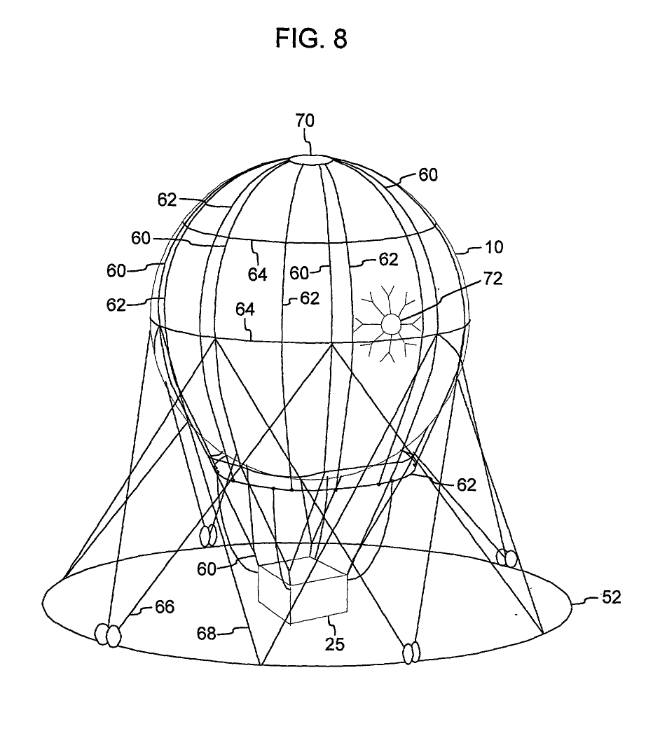

FIG. 8 shows a heavy cargo transport system in another aspect of the present invention. As shown in FIG. 8, the balloon 10 includes suspension lines 60, lighting cables 62, lateral lines 64, handling lines 66, mooring lines 68 and an apex ring 70. The suspension lines 60 and the lighting cables 62 all connect to the apex ring 72. The suspension lines 60, preferably constituting eight lines total, combine into four junctions for attachment to the payload box 25. The handling lines 66 and the mooring lines 68 also preferably constitute eight lines each. The handling lines 66 are used for mooring the balloon 10 in a “flying” configuration and mooring lines 68 are used for storm mooring. The handling lines 66 and mooring lines 68 are tied to the ground by the winches 45 (not shown in FIG. 8) around the ring 52. In this configuration, the payload box 25 may have a length of about 13 meters and a height and depth of 6 meters each.

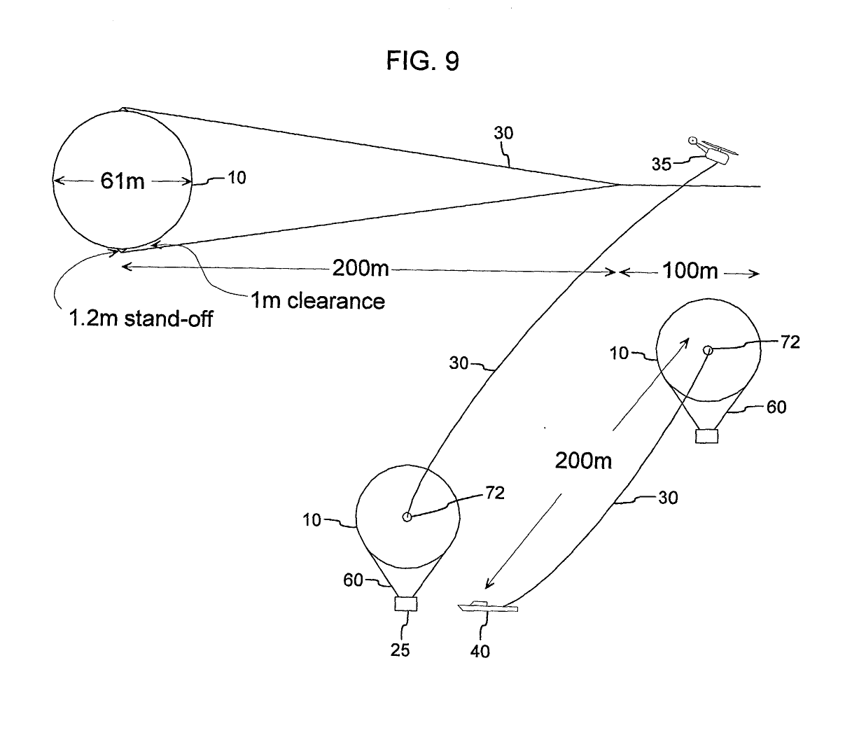

The balloon 10 in FIG. 8 also includes two pick-up or tow points 72 located on diametrically opposite sides of the equator of the balloon 10. In operation, the balloon 10 and payload box 25 may be lifted by a helicopter 35 by direct vertical lifting from overhead. This operation is generally depicted in FIG. 9. As shown in FIG. 9, the tow cable 30 connected to the helicopter 35 may be about 300 meters in length. At a point about 100 meters from the helicopter 35, the tow cable 30 splits to enable the tow cable 30 to attach to the two tow points 72 of the balloon 10. The point of attachment to the balloon may actually be some short distance from the surface of the balloon, such as about 1.2 meters. The balloon 10 itself may have a diameter of about 61 meters. Instead of the helicopter 35, the balloon 10 may be attached to ground mover 40, as shown in FIG. 9. When connected to the ground mover 40, the tow cable 30 may be about 200 meters in length. The tow cable 30 may use a 12-strand Vectran rope, or other high tenacity cable, to minimize weight impact of the tow bridle on the transport system.

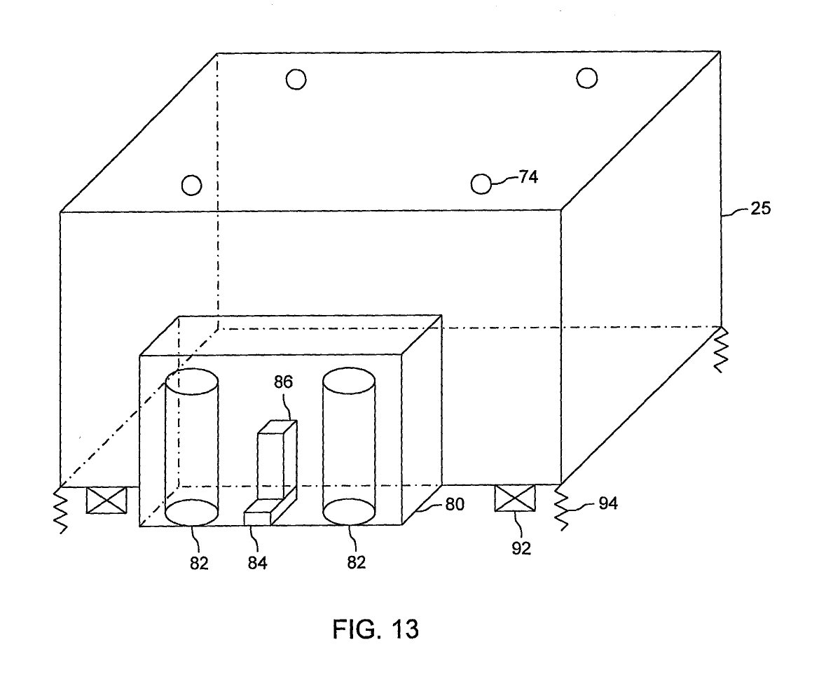

There may be twelve lightning cables 62, which run on the surface of the envelope of the balloon 10 from the apex ring 70 at the top of the balloon 10 to the lower portion of the balloon 10, and which are evenly spaced on the surface of the balloon 10. The lightning cables 62 may be bonded to the apex ring 70 and the ARDD device assembly 44, and may then run down the sides of the balloon 10 and culminate into a ring at the lower portion of the balloon 10, such as shown in FIG. 8. The lightning cables may then be terminated into a single lightning drain wire, which connects these lines to each of the four corners of the payload box 25 in a manner that routes the lightning down to the ground and into four chains 94, shown in FIG. 13, located at the lower portion of each corner of the payload box 25. The payload box 25 may have the chains 94 or a “trailing wire” suitably bonded electrically to the outer metallic frame of the payload box 25, and which is used to ground the transport system during landing.

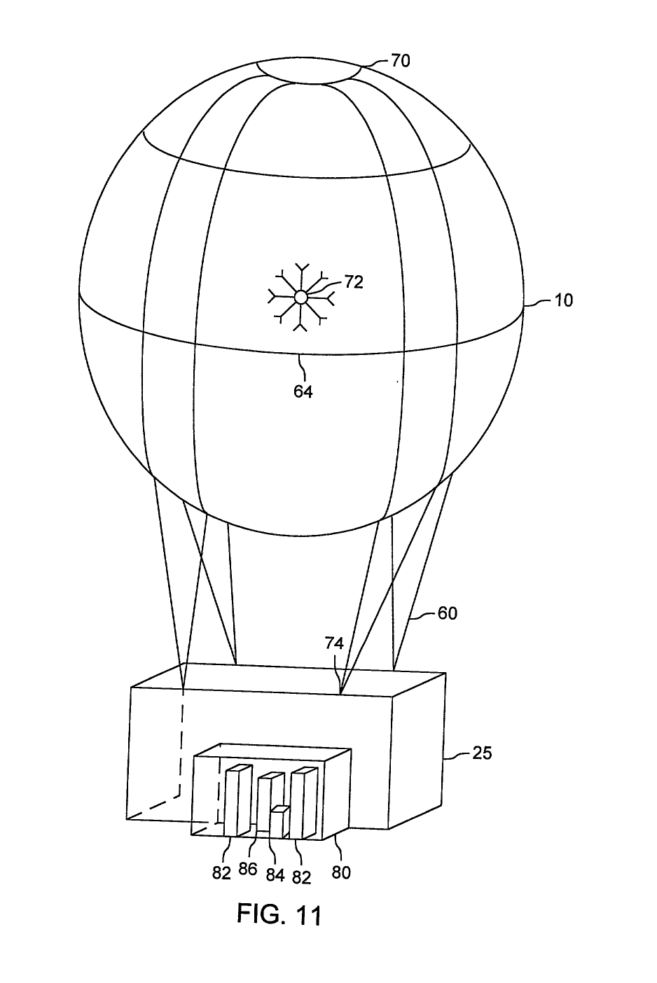

FIG. 11 shows additional elements of the heavy cargo transport system of FIG. 8. As shown in FIG. 11, there are preferably eight suspension lines 60. The eight suspension lines culminate into four attachment points or junctions 74 on the payload box 25. As further shown in FIG. 11, the transport system includes an external systems platform 80. Although only one platform 80 is shown, there is preferably another platform 80 on the opposite side of the payload box 25. Each platform 80 includes a pair of main ballast tanks 82, a generator 84 and a trim tank 86. The generator 84 may be, for example, a 26 kW generator. The ballast tanks 82 and trim tank 86 are preferably filled with water, which is drained when payload is placed into the payload box 25. The ballast tanks 82 and the trim tank 86 serve as fine adjustments to the heaviness or lightness of the transport system. In other words, the tanks can adjust the relative difference of the buoyant lift of the balloon 10 to the weight of the payload box 25. The system static heaviness is thus adjustable for a transport mission. The adjustment of the tanks may be performed by a flight control computer system resident on the payload box 25 or in the tow vehicle.

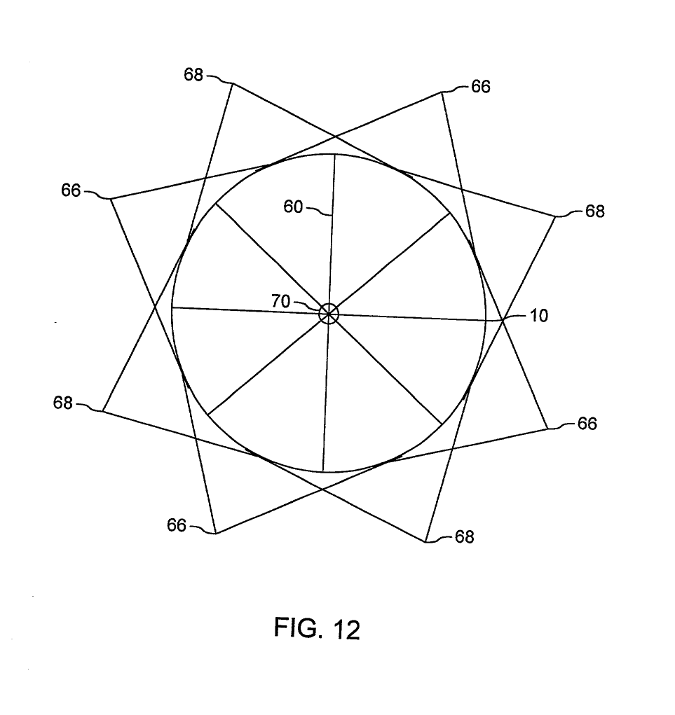

As shown in FIG. 12, the eight mooring lines 68 may culminate into four lines and then may be attached to four winches 45 for mooring the balloon 10 when winds in excess of 60 knots are anticipated. Typically, the eight handling lines 66 may culminate into four points on the ground and may be attached in a manner which is sufficient to position and hold secure the balloon 10 when the balloon 10 is attached to the payload box and ballast system. The handling lines 66 may be configured so as to cause restraint of the balloon 10 regardless of wind direction.

Alternatively, the mooring system may comprise a ring configured to act as a catcher's mitt for the balloon 10. When winds are predicted to exceed 60 knots at the ground, this mooring system may be used to secure the balloon 10. Using a simple structural ring, this mooring system pulls the balloon 10 into the ring snugly to moor it onto the ground. Unlike shaped aerodynamic vehicles, this system has no preferred orientation to the wind.

During the flight operations, if the lifting gas temperature is rising due to superheat at the beginning of the flight, the system lift will become greater. With this operation, the transport system of FIG. 8 is preferably flown at approximately 6,000 pounds heavy at the start of the mission, but ends up in the order of 6,000 pounds heavy minus the superheat value, which is still slightly heavy. If the lifting gas temperature is falling due to supercool at the beginning of the flight, then the trim tanks 86 can be used to dump ballast during towing operations to maintain the desired level of system heaviness. Thus, the transport system has active ballast control during flight and towing operations.

The two generators 84 may power airborne pressurization blowers and telemetry systems, as well as the control systems of the payload box 25. The generators 84 provide redundancy and extra power during times of maximum descent of the transport system, and thus maintain system shape.

The pressurization subsystem may comprise a suitable AC power distribution system on the balloon 10 which is run from the generators 84 located on the payload box 25. The system may be configured with a DC back-up pressurization sub-system in the event the main power fails for any reason. The DC power subsystem may be capable of operation for up to two hours after it is fully engaged.

The transport systems of FIG. 3 and FIG. 8 preferably fly at an altitude not exceeding about 2,000 ft AMSL. The systems may also be moored normally in the flying position. If winds are predicted to exceed 60 knots, the system may be moored to a ground-based mooring system ring, or alternatively cinched down to the ground to withstand extremely high winds, such as shown in FIG. 6.

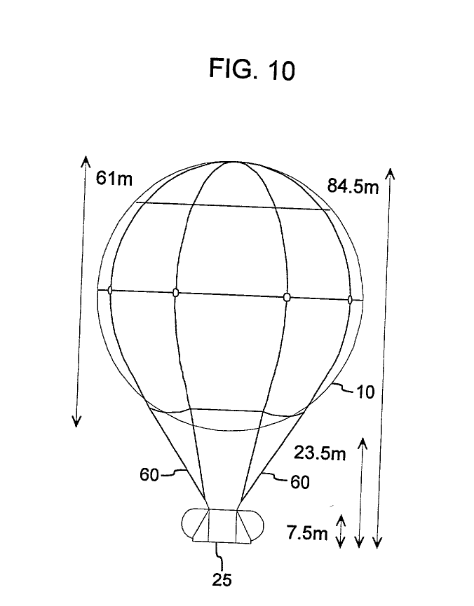

The balloon 10 is preferably inflated with helium, or alternate lifting gas. The balloon 10 preferably includes a non-rigid structure with an internal ballonet, or air compartment within the helium chamber, also constructed of flexible material. The balloon 10 in the transport system of FIG. 3 may include a series of load patches, as shown in FIG. 3A, connected to a set of confluence lines culminating into a single junction, and four additional mooring lines may be used for close ground handling purposes. The transport system of FIG. 8, however, need not incorporate load patches. Rather, it may include a system of cables arranged so that they are positioned around the sphere in a manner such that they create an effective net to capture the sphere. The system of cables includes a series of lateral lines 64 and suspension lines 60, as shown in FIGS. 10 and 11.

The transport systems of FIGS. 3 and 8 preferably include airborne electronics having integral lightning protection with isolation devices integrated into all on-board electronic boxes. The electronics may include an ARDD (Airborne System Rapid Deflation Device) device (see FIG. 3A) with integral GPS for remote tracking, and can have the ability to send status of the pressurization of the balloon 10 and ambient air as well as helium temperature to a flight control computer on the tow vehicle, i.e. the helicopter 35 or the ground mover 40. The flight control computer may display static heaviness of the balloon 10 and the payload box 25 combination to ensure safety during payload transport operations. The transport systems of FIGS. 3 and 8 may include other elements not otherwise shown in the figures, including blowers and helium and air valves.

In the transport system of FIG. 8, the balloon 10 and payload box 25 may be connected, as previously discussed, via eight suspension cables 60, with separate signal and power cables running between the balloon 10 and the payload box 25, as well as between the helicopter 35 or ground tow vehicle 40 and the balloon 10. The transport system may be designed preferably to withstand towing in relative winds up to and including 60 knots.

As shown in FIG. 13, the payload box 25 may be configured with a set of air springs 92, which are configured to prevent horizontal translation upon landing or takeoff from damaging them. The air springs 92 may be incorporated into the bottom of the payload box 25 to cushion the payload and to facilitate soft landings. The air springs 92 may include a set of cross straps for this purpose and are configured so as to prevent lateral damage during landing operations.

As further shown in FIG. 13, the payload box 25 may also include a set of chains 94, which may be used to ground the payload box 25. The chains 94 may be positioned at the bottom corners of the payload box 25 and are securely bonded to the lightning protection systems. The chains 94 touch the ground prior to the payload box itself 25 and serve to discharge any static voltage which may have accumulated during the helicopter 35 towed flights through the atmosphere.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

We claim:

1. A payload transport system comprising:
a tow cable connectable at a first end to a towing vehicle;
a buoyant lift vehicle comprising an inflatable member;
a tether cable linked to said buoyant lift vehicle and having a connection with said tow cable; and
a payload connector linked to at least one of said payload tether cable and said tow cable.

2. An apparatus as recited in claim 1, said tow cable having a tow vehicle connector at said first end.

3. An apparatus as recited in claim 1, further comprising a connector linking said tether cable and said tow cable.

4. An apparatus as recited in claim 1, said payload connector linking ends of said tether cable and said tow cable.

5. An apparatus as recited in claim 4, said ends comprising an end of said tether cable distal from said buoyant lift vehicle and an end of said tow cable distal from said first end thereof.

6. An apparatus as recited in claim 1, said payload connector being connectable to a payload.

7. An apparatus as recited in claim 1, said buoyant lift vehicle comprising an aerostat.

8. An apparatus as recited in claim 7, said aerostat comprising a non-rigid lighter than air vehicle.

9. An apparatus as recited in claim 8, said aerostat having a substantially constant drag coefficient under predetermined transport conditions.

10. An apparatus as recited in claim 9, said drag coefficient being less than about 0.20.

11. An apparatus as recited in claim 1, comprising a plurality of confluence lines attached to said buoyant lift vehicle and a slip ring, said confluence lines and an end of said tether cable being linked to said slip ring.

12. An apparatus as recited in claim 11, said payload connector being at an end of said tether cable distal from said end of said payload tether cable linked to said slip ring.

13. An apparatus as recited in claim 12, said payload connector comprising a tri-plate connector.

14. An apparatus as recited in claim 4, said payload connector comprising a tri-plate connector.

15. An apparatus as recited in claim 1, further comprising a payload rack linked to said payload connector.

16. An apparatus as recited in claim 15, said tether cable comprising electrical conductors.

17. An apparatus as recited in claim 16, said electrical conductors being adapted to connect to a source of electrical power at an end proximate to said payload racks and conduct electrical current to airborne devices.

18. An apparatus as recited in claim 17, said airborne devices comprising buoyant lift vehicle pressure maintenance equipment.

19. An apparatus as recited in claim 17, said pressure maintenance equipment comprising blowers and controls.

20. An apparatus as recited in claim 17, said airborne devices comprising navigational equipment.

21. An apparatus as recited in claim 1, further comprising lighting suppression equipment.

22. An apparatus as recited in claim 1, further comprising at least one mooring line connected to said buoyant lift vehicle.

23. An apparatus as recited in claim 1, further comprising a tension.

24. A payload transport system comprising:
a vehicle adapted for inflation to lift a payload under predetermined transport conditions;
a tether cable for linking said vehicle to said payload; and
a tow cable connected to said tether cable at one end, and adapted for connection at another end to a tow vehicle.

25. An apparatus as recited in claim 24, wherein when inflated, said vehicle has a Reynolds number in a range corresponding to a substantially constant drag coefficient for predetermined transport conditions.

26. An apparatus as recited in claim 25, said Reynolds number being greater than about 600,000.

27. An apparatus as recited in claim 25, said drag coefficient being less than about 0.2.

28. An apparatus as recited in claim 25, further comprising a plurality of confluence lines, said confluence lines being attached to said vehicle at lead patches.

29. An apparatus as recited in claim 28, wherein said confluence lines culminate in a single junction, and further comprising a slip ring, said single junction and said tether cable being linked at said slip ring.

30. An apparatus as recited in claim 29, said slip ring being adapted to swivel.

31. An apparatus as recited in claim 25, said tether cable having electrical conductors adapted for connection to a power source at a payload end and for connection to airborne equipment at an opposite end.

32. An apparatus as recited in claim 25, further comprising a mooring line.

33. An apparatus as recited in claim 25, further comprising lighting suppression equipment.

34. A payload transport system comprising:
an aerostat inflatable to a size wherein said aerostat has a Reynolds number in a range producing a substantially constant drag coefficient for predetermined transport conditions;
a tether cable linking said aerostat to a payload; and
a tow cable adapted to connect to a tow vehicle at one end and to connect at another end to tow said payload lifted by said aerostat.

35. An apparatus as recited in claim 34, said aerostat having a Reynolds number of at least 600,000.

36. An apparatus as recited in claim 35, said aerostat having a drag coefficient of less than about 0.2.

37. An apparatus as recited in claim 34, further comprising confluence lines connected to said aerostat.

38. An apparatus as recited in claim 37, further comprising a slip ring, said confluence lines and said tether cable being linked at said slip ring.

39. An apparatus as recited in claim 38, said tether cable having electrical conductors adaptable for connection to a power source above end and equipment airborne in said aerostat at another end thereof.

40. A method of configuring a payload for transport, the method comprising:
connecting said payload to an aerostat inflated to a size where said aerostat has a Reynolds number in a range corresponding to a substantially constant drag coefficient under predetermined transport conditions;
connecting said payload and said aerostat to a tow vehicle through a tow cable.

41. A method according to claim 40, further comprising:
towing said payload with a tow vehicle.

42. A payload transport system comprising:
a buoyant lift vehicle comprising an inflatable member;
a payload frame having active ballast control and integral power generation; and
a first plurality of suspension lines attached to the buoyant lift vehicle culminating into a second plurality of attachment points on the payload frame.

43. A system according to claim 42, wherein the buoyant lift vehicle include two attachment points that are diametrically opposed to each other on opposite sides of the buoyant lift vehicle,

44. A system according to claim 43, wherein the buoyant lift vehicle is picked up by the two attachment points.
